(19) United States
(12) Patent Application Publication
(10) Pub. No.: US 2025/0097744 A1
(43) Pub. Date: Mar. 20, 2025

(54) METHOD FOR TRANSMITTING CAPABILITY INFORMATION, AND DEVICE

(71) Applicant: GUANGDONG OPPO MOBILE TELECOMMUNICATIONS CORP., LTD., Dongguan (CN)

(72) Inventors: Ning GAO, Dongguan (CN); Lei HUANG, Singapore (SG)

(21) Appl. No.: 18/954,485

(22) Filed: Nov. 20, 2024

Related U.S. Application Data
(63) Continuation of application No. PCT/CN2022/098488, filed on Jun. 13, 2022.

(51) Int. Cl. H04W 24/08; H04W 84/12

(52) U.S. Cl. CPC H04W 24/08; H04W 84/12

(57) ABSTRACT

Provided is a method for transmitting capability information. The method includes: transmitting, by a first wireless device, capability information related to a sensing measurement to a second wireless device, wherein the capability information related to the sensing measurement comprises at least one of capability information of a first granularity or capability information of a second granularity, wherein the first granularity is greater than the second granularity.

### CROSS-REFERENCE TO RELATED APPLICATION

This application is a continuation application of international application No. PCT/CN2022/098488, filed on Jun. 13, 2022, the entire contents of which are incorporated herein by reference.

### TECHNICAL FIELD

The present disclosure relates to the field of sensing measurement, and in particular, relates to a method and apparatus for transmitting capability information, and a device and a storage medium thereof.

### BACKGROUND

Wireless local area network (WLAN) sensing refers to a technique for sensing a person or an object in an environment by detecting changes of WLAN signals scattered and/or reflected by the person or the object.

### SUMMARY

Embodiments of the present disclosure provide a method for transmitting capability information, and a device. The technical solutions are as follows.

According to some embodiments of the present disclosure, a method for transmitting capability information is provided. The method includes: transmitting, a first wireless device, capability information related to a sensing measurement to a second wireless device, wherein the capability information related to the sensing measurement includes at least one of capability information of a first granularity or capability information of a second granularity, wherein the first granularity is greater than the second granularity.

According to some embodiments of the present disclosure, a device for sensing measurement is provided. The device for sensing measurement includes: a processor; a transceiver, communicably connected to the processor; and a memory, configured to store one or more executable instructions. The processor, when loading and executing the one or more executable instructions, causes the device for sensing measurement to perform the method for transmitting capability information as described above.

According to some embodiments of the present disclosure, a device for sensing measurement is provided. The device for sensing measurement includes: a processor; a transceiver, communicably connected to the processor; and a memory, configured to store one or more executable instructions. The processor, when loading and executing the one or more executable instructions, causes the device for sensing measurement to perform: receiving, by a second wireless device, capability information related to a sensing measurement from a first wireless device, wherein the capability information related to the sensing measurement includes at least one of capability information of a first granularity or capability information of a second granularity, wherein the first granularity is greater than the second granularity.

### BRIEF DESCRIPTION OF THE DRAWINGS

For clearer descriptions of the technical solutions according to the embodiments of the present disclosure, the accompanying drawings required for describing the embodiments are briefly introduced hereinafter. Apparently, the accompanying drawings in the following description show merely some embodiments of the present disclosure, and those of ordinary skill in the art may still derive other drawings from these accompanying drawings without creative efforts.

FIG. 1 is a schematic diagram of a sensing measurement system according to some exemplary embodiments of the present disclosure;

FIG. 2 is a schematic diagram of a sensing process according to some exemplary embodiments of the present disclosure;

FIG. 3 is a schematic diagram of a sensing process according to some exemplary embodiments of the present disclosure;

FIG. 4 illustrates a schematic flowchart of a WLAN sensing session in the related art;

FIG. 5 illustrates a schematic flowchart of establishing a trigger-based (TB) sensing measurement in the related art;

FIG. 6 illustrates a schematic flowchart of establishing a TB sensing measurement in the related art;

FIG. 7 illustrates a schematic flowchart of a TB sensing measurement setup phase in the related art;

FIG. 8 illustrates a schematic flowchart of a TB sensing measurement phase in the related art;

FIG. 9 illustrates a schematic flowchart of a TB sensing reporting phase in the related art;

FIG. 10 illustrates a schematic flowchart of a non-trigger-based (non-TB) sensing measurement setup phase in the related art;

FIG. 11 illustrates a schematic flowchart of a non-TB sensing measurement phase in the related art;

FIG. 12 illustrates a flowchart of a method for transmitting capability information according to some schematic embodiments of the present disclosure;

FIG. 13 illustrates a schematic diagram of a method for transmitting capability information according to some schematic embodiments of the present disclosure;

FIG. 14 illustrates a schematic diagram of capability information related to a sensing measurement according to some schematic embodiments of the present disclosure;

FIG. 15 illustrates a schematic diagram of capability information related to a sensing measurement according to some schematic embodiments of the present disclosure;

FIG. 16 illustrates a structural block diagram of an apparatus for transmitting capability information according to some schematic embodiments of the present disclosure;

FIG. 17 illustrates a structural block diagram of an apparatus for receiving capability information according to some schematic embodiments of the present disclosure; and

FIG. 18 illustrates a schematic diagram of a communication device for capability information according to some schematic embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings. Exemplary embodiments are described in detail herein, with examples illustrated in the accompanying drawings. When the following description refers to the accompanying drawings, the same numbers in different accompanying drawings represent the same or similar elements unless otherwise indicated. The embodiments described in the following exemplary embodiments do not represent all embodiments consistent with the present disclosure. Rather, they are merely examples of apparatus and methods consistent with some aspects of the present disclosure, as detailed in the appended claims.

The terms used in the present disclosure are for the purpose of describing specific embodiments only and are not intended to limit the present disclosure. As used in the present disclosure and the appended claims, the articles “a,” “an,” and “the” are intended to include the plural forms as well, unless the context clearly indicates otherwise. It should also be understood that the phrase “and/or” as used herein refers to and encompasses any or all possible combinations of one or more associated listed items.

It should be understood that although the terms “first,” “second,” “third,” and the like may be used in the present disclosure to describe various information, such information should not be limited to these terms. These terms are only used to distinguish the same type of information from one another. For example, first information may also be referred to as second information, and similarly, second information may also be referred to as first information, without departing from the scope of the present disclosure. The word “in a case that” herein may be interpreted as “in the case that,” “in the case of,” “when,” “upon,” or “in response to determining”, depending on the context.

First, some terms involved in the embodiments of the present disclosure are described hereinafter.

An association identifier (AID) identifies a terminal associated with an access point (AP).

Wireless sensing, also referred to as sensing measurement, refers to a technique for sensing a person or an object in an environment by detecting changes of wireless signals scattered and/or reflected by the person or the object. The wireless signals may be wireless signals in a cellular network, WLAN signals, or the like.

WLAN sensing refers to sensing a person or an object in an environment by detecting changes of WLAN signals scattered and/or reflected by the person or the object. That is, in the WLAN sensing, a surrounding environment is measured and detected based on wireless signals to implement various functions such as detection of indoor intrusions/movements/fall, gesture recognition, spatial three dimensions image construction, and the like.

Proxy sensing measurement refers to a device for sensing measurement requesting other devices for sensing measurement, other than the device itself, to perform a sensing measurement on behalf of the device. For example, an AP requests a station (STA) to perform a sensing measurement instead on behalf of the AP, or an STA requests an AP to perform a sensing measurement on behalf of the STA.

A WLAN device participating in WLAN sensing may function as:
a sensing initiator, which is a device that initiates a sensing measurement and desires to acquire a sensing result;
a sensing responder, which is a device other than the sensing initiator that participates in the sensing measurement;
a sensing signal transmitter, or referred to as a sensing transmitter, which is a device that transmits a sensing measurement signal (sensing illumination signal);
a sensing signal receiver or sensing receiver, which is a device that receives a sensing measurement signal;
a sensing-by-proxy initiator, also referred to as a sensing-by-proxy requester, which is a device that requests other devices to initiate a sensing measurement; or
a sensing-by-proxy responder, also referred to as a sensing proxy STA or a sensing proxy responder, which is a device that responds to a request from the sensing-by-proxy initiator and initiates a sensing measurement.

In WLAN sensing, a WLAN terminal plays one or more roles in a sensing measurement. For example, the sensing initiator may just function as a sensing initiator or may function as a sensing signal transmitter, a sensing signal receiver, or functions as both a sensing signal transmitter and a sensing signal receiver.

Next, the related technical backgrounds involved in the embodiments of the present disclosure are described hereinafter.

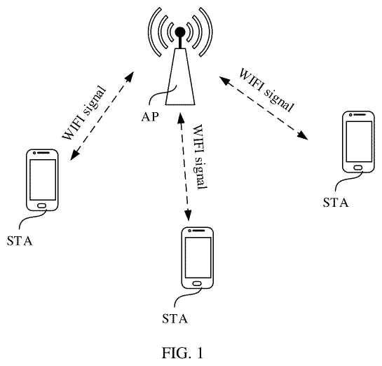

FIG. 1 illustrates a block diagram of a sensing measurement system according to some exemplary embodiments of the present disclosure. The sensing measurement system may involve interactions between different devices, for example, between different terminals, between a terminal and a network device, or between an AP and an STA, which is not limited in the present disclosure. In the present disclosure, the sensing measurement system including an AP and an STA is used as an example for description.

In some scenarios, the AP is also referred to as an AP STA. That is, the AP is an STA in some way. In some scenarios, the STA is also referred to as a non-AP STA.

In some embodiments, STAs include an AP STA and a non-AP STA.

The communication within the communication system involves communication between the AP and the non-AP STA, communication between non-AP STAs, or communication between the STA and a peer STA. The peer STA refers to a device communicating with the STA at a peer end. For example, the peer STA is an AP or a non-AP STA.

The AP is a bridge to connect a wired network to a wireless network, and mainly functions to connect various wireless network clients and then connect the wireless network to the Ethernet. The AP device is a terminal device (for example, a mobile phone) equipped with a wireless-fidelity (Wi-Fi) chip or a network device (for example, a router).

It should be understood that role of the STA in the communication system is not definite (the STA may function differently according to actual needs). For example, in some scenarios, the mobile phone is a non-AP STA in the case that a mobile phone is connected to a router, and the mobile phone is an AP in the case that the mobile phone serves as a hotspot for other mobile phones.

Both the AP and the non-AP STA are devices applicable to the Internet of vehicles, nodes and sensors in the Internet of things (IoT), smart cameras, smart remote controls, smart water meters and electricity meters in smart homes, sensors in smart cities, and the like.

In some embodiments, the non-AP STA supports an 802.11be format. In some embodiments, the non-AP STA also supports various current and future WLAN formats of the 802.11 family, such as 802.11ax format, an 802.11ac format, an 802.11n format, an 802.11g format, an 802.11b format, an 802.11a format, and the like.

In some embodiments, the AP supports the 802.11be format. In some embodiments, the AP is also a device that supports various current and future WLAN formats of the 802.11 family, such as an 802.11ax format, an 802.11ac format, an 802.11n format, an 802.11g format, an 802.11b format, an 802.11a format, and the like.

In the embodiments of the present disclosure, the STA is a device that supports WLAN/Wi-Fi, such as a mobile phone, a pad, a computer, a virtual reality (VR) device, an augmented reality (AR) device, a wireless device in industrial control, a set-top box, a wireless device in self-driving, an in-vehicle communication device, a wireless device in remote medical, a wireless device in smart grid, a wireless device in transportation safety, a wireless device in smart city or smart home, a wireless communication chip/application specific integrated circuit (ASIC)/system on chip (SoC), and the like.

Frequency bands supported by the WLAN include but are not limited to low-frequency bands (2.4 GHz, 5 GHz, and 6 GHz) and high-frequency bands (45 GHz and 60 GHz).

One or more links are present between the STA and the AP.

In some embodiments, the STA and the AP support multi-frequency-band communications, for example, simultaneous communications at frequency bands of 2.4 GHz, 5 GHz, 6 GHz, 45 GHz, and 60 GHz, or simultaneous communications in different channels at the same frequency band (or different frequency bands), such that the communication throughput and/or reliability between devices are improved. Such devices are generally referred to as multi-frequency-band devices, multi-link devices (MLDs), multi-link entities, or multi-frequency-band entities. The MLD is an AP device or an STA device. In the case that the MLD is an AP device, the MLD includes one or more APs. In the case that the MLD is an STA device, the MLD includes one or more non-AP STAs.

The MLD including one or more APs is also referred to as an AP, and the MLD including one or more non-AP STAs is also referred to as a non-AP. In the embodiments of the present disclosure, the non-AP is also referred to as an STA.

In the embodiments of the present disclosure, the AP includes a plurality of APs, the non-AP includes a plurality of STAs, a plurality of links are formed between the APs in the AP and the STAs in the non-AP, and data communication between the APs in the AP and the corresponding STAs in the non-AP is achieved over the corresponding links.

The AP is a device deployed in a WLAN to provide a wireless communication function for the STA. The STA includes: user equipment (UE), an access terminal, a subscriber unit, a subscriber station, a mobile station, a mobile terminal, a remote station, a remote terminal, a mobile device, a wireless communication device, a user agent, a user apparatus, or the like. In some embodiments, the STA is a cellular phone, a cordless phone, a session initiation protocol (SIP) phone, a wireless local loop (WLL) station, a personal digital assistant (PDA), a handheld device with a wireless communication function, a computing device or another processing device connected to a wireless modem, a vehicle-mounted device, or a wearable device, which is not limited in the embodiments of the present disclosure.

In some embodiments of the present disclosure, the STA and the AP both support the IEEE 802.11 standard, but are not limited to the IEEE 802.11 standard.

In a WLAN sensing scenario, WLAN terminals participating in sensing include a sensing session initiator and a sensing session responder. Alternatively, WLAN terminals participating in sensing include a sensing signal transmitter and a sensing signal receiver. The sensing session initiator is a sensing initiator for short, and the sensing session responder is a sensing responder for short.

The sensing measurement may be appliable to a cellular network communication system, a WLAN system, or a wireless communication (Wi-Fi) system, which is not limited in the present disclosure. In the present disclosure, schematic description is given using the case where the sensing measurement is appliable to a WLAN or Wi-Fi system.

FIGS. 2 (1) to (6) illustrate six typical scenarios of sensing measurement based on sensing signals according to some exemplary embodiments of the present disclosure.

In some exemplary embodiments, the sensing measurement is a one-way interaction process where one STA transmits a sensing signal to another STA. As shown in FIG. 2 (1), in the sensing measurement, an STA 2 transmits a sensing signal to an STA 1.

In some exemplary embodiments, the sensing measurement is an interaction process between two STAs. As shown in FIG. 2 (2), in the sensing measurement, an STA 1 transmits a sensing signal to an STA 2, and the STA 2 transmits a measurement result to the STA 1.

In some exemplary embodiments, the sensing measurement is a combination of a plurality of one-way information interaction processes. As shown in FIG. 2 (3), in the sensing measurement, an STA 3 transmits a sensing signal to an STA 2, and the STA 2 transmits a measurement configuration to an STA 1.

In some exemplary embodiments, in the sensing measurement, each of a plurality of STAs transmits a sensing signal to the same STA. As shown in FIG. 2 (4), in the sensing measurement, each of an STA 2 and an STA 3 transmits a sensing signal to an STA 1.

In some exemplary embodiments, the sensing measurement involves information interaction between one STA and each of a plurality of other STAs. As shown in FIG. 2 (5), in the sensing measurement, an STA 1 transmits a sensing signal to an STA 2 and an STA 3, respectively, and each of the STA 2 and the STA 3 transmits a measurement configuration to the STA 1.

In some exemplary embodiments, as shown in FIG. 2 (6), in the sensing measurement, each of a plurality of STAs (e.g., an STA 3 and an STA 4) transmits a sensing signal to an STA 2, and the STA 2 transmits a measurement result to an STA 1.

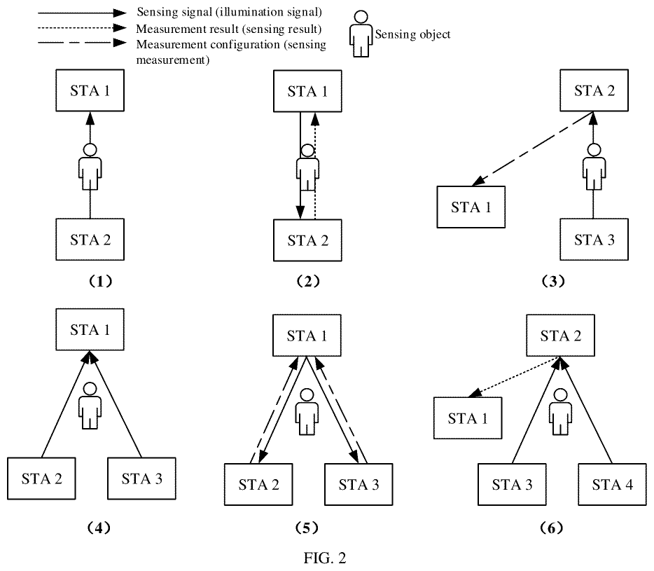

FIGS. 3 (1) to (4) illustrate four typical scenarios of sensing measurement based on sensing signals and reflected signals according to some exemplary embodiments of the present disclosure.

In some exemplary embodiments, as shown in FIG. 3 (1), a sensing signal from an STA 1 reaches a sensing object, the sensing object reflects the sensing signal, and the STA 1 receives the reflected signal.

In some exemplary embodiments, as shown in FIG. 3 (2), a sensing signal from an STA 2 reaches a sensing object, the sensing object reflects the sensing signal, and the STA 2 receives the reflected signal.

In some exemplary embodiments, as shown in FIG. 3 (3), sensing signals from both an STA 1 and an STA 2 reach a sensing object, the sensing object separately reflects the sensing signals from the STA 1 and the STA 2, the STA 1 and the STA 2 respectively receive the signals reflected by the sensing object, and the STA 2 transmits a measurement result to the STA 1 (that is, the measurement result is synchronously shared between the STAs).

In some exemplary embodiments, as shown in FIG. 3 (4), sensing signals from both an STA 3 and an STA 2 reach a sensing object, the sensing object separately reflects the sensing signals from the STA 3 and the STA 2, the STA 3 and the STA 2 respectively receive the signals reflected by the sensing object, the STA 3 transmits a measurement result to the STA 1 and the STA 2, respectively, and the STA 2 also transmits a measurement result to the STA 1 (that is, the measurement results are synchronously shared among the STAs).

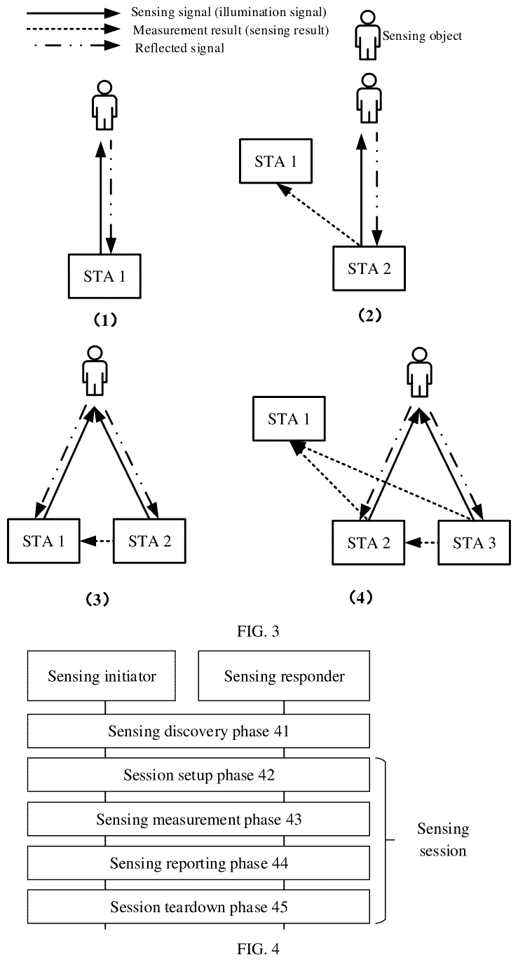

As shown in FIG. 4, the WLAN sensing session includes one or more of the following phases: a sensing discovery phase 41, a session setup phase 42, a sensing measurement phase 43, a sensing reporting phase 44, and a session teardown phase 45.

The sensing discovery phase 41 is for initiating a sensing session.

The session setup phase 42 is for establishing the sensing session, determining participants of the sensing session and their roles (including a sensing signal transmitter and a sensing signal receiver), deciding operation parameters related to the sensing session, and optionally exchanging the parameters between terminals.

The sensing measurement phase 43 is for conducting the sensing measurement, wherein the sensing signal transmitter transmits a sensing signal to the sensing signal receiver.

The sensing reporting phase 44 is for reporting a measurement result; depending on the application scenario, the sensing receiver may need to report the measurement result to the sensing measurement initiator.

In the session teardown phase 45, the terminal stops the measurement and terminates the sensing session.

The same device for sensing measurement may play one or more roles in a sensing session. For example, the sensing session initiator may just be a sensing session initiator or may be a sensing signal transmitter, a sensing signal receiver, or both a sensing signal transmitter and a sensing signal receiver.

The sensing measurement process may be at least divided into: a trigger-based (TB) sensing measurement process and a based non-trigger (based non-TB) sensing measurement process. Based non-trigger is also referred to as non-trigger-based (non-TB).

### TB Sensing Measurement Process:

In a TB sensing measurement, the process of establishing a sensing measurement procedure between an STA and an AP is shown in FIG. 5.

Firstly, the STA acquires the wireless network information of the AP by passive scanning or active scanning, thereby knowing the distribution of surrounding wireless networks.

Passive scanning: The STA passively monitors a beacon frame periodically broadcast by the AP on a specified channel. The beacon frame may carry information such as capability information and a service set identifier (SSID).

Active scanning: The STA actively transmits a probe request frame to the AP and receives a probe response frame returned by the AP. The probe request frame and the probe response frame may carry information such as capability information, an SSID, and an extended capability. The capability information in the above different frames refers to the capability information of a device transmitting the current frame.

Secondly, the STA establishes an association relationship with an AP based on the acquired wireless network information of the AP, thereby acquiring a full access to the wireless network to become an associated STA.

In the case that the STA is connected to an AP for the first time, the STA unicasts an association request frame to the AP and receives an association response frame returned by the AP. The association request frame may carry information such as capability information, a listen interval, an SSID, a supported rate, and a quality of service (QoS) capability. The association response frame may carry information such as capability information, a status code, an association identifier (AID), and an extended capability.

In the case that the STA is not connected to an AP for the first time, the STA unicasts a reassociation request frame to the AP and receives a reassociation response frame returned by the AP. Information carried by the reassociation request frame and the reassociation response frame is similar to that carried by the association request frame and the association response frame.

Thirdly, based on the various capability information interaction between the STA and the AP in the above part, the AP transmits a sensing measurement set request frame (MS request frame) to the associated STA and receives a returned sensing measurement set response frame (MS response frame), thereby completing the setup of one sensing measurement. The MS request frame may carry information such as a measurement frame (null data physical layer protocol data unit, NDP) bandwidth, an NDP type, and a reporting type; and the MS response frame may carry information such as a status code.

At last, a sensing measurement instance is established between the associated STA and the AP, and the transmission and reception of NDPs is started and channel sensing is conducted.

In a TB sensing measurement, the process of establishing a sensing measurement between a non-associated STA and an AP is shown in FIG. 6.

The process of establishing sensing between a non-associated STA and an AP is similar to that of an associated STA. Both use the beacon frame, the probe request frame, and the probe response frame to scan the wireless network information of the AP.

The difference is that the non-associated STA does not need to establish an association relationship with the AP. That is, the non-associated STA neither needs to transmit an association request frame to the AP and receive an association response frame, nor needs to transmit a reassociation request frame to the AP and receive a reassociation response frame. The non-associated STA is capable of transmitting a sensing measurement setup query frame (MS query frame) to the AP to initiate a sensing measurement setup step after scanning, and then complete the sensing measurement setup step by receiving an MS request frame and transmitting an MS response frame.

At last, a sensing measurement instance is established between the non-associated STA and the AP, starting the transmission and reception of NDPs and conducting channel sensing.

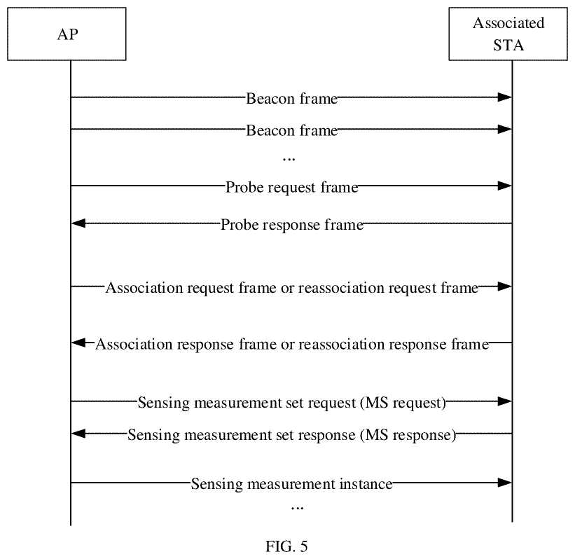

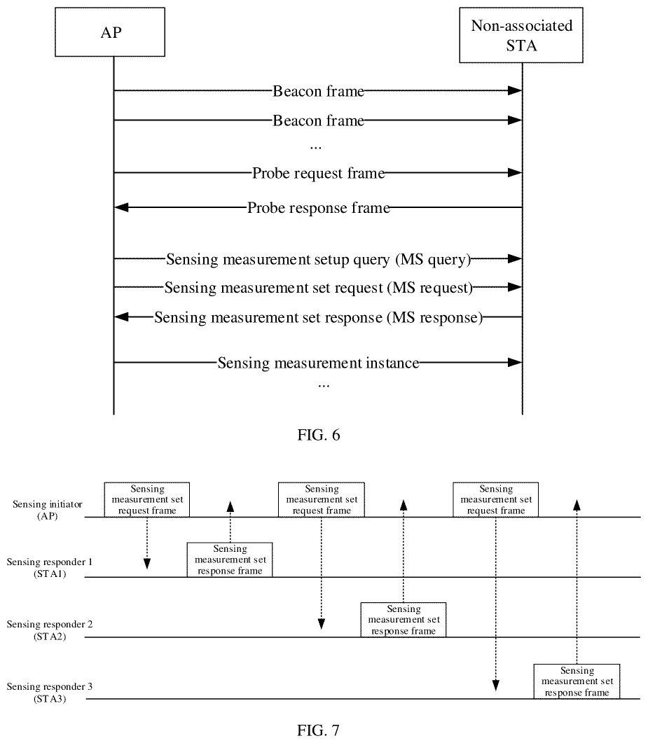

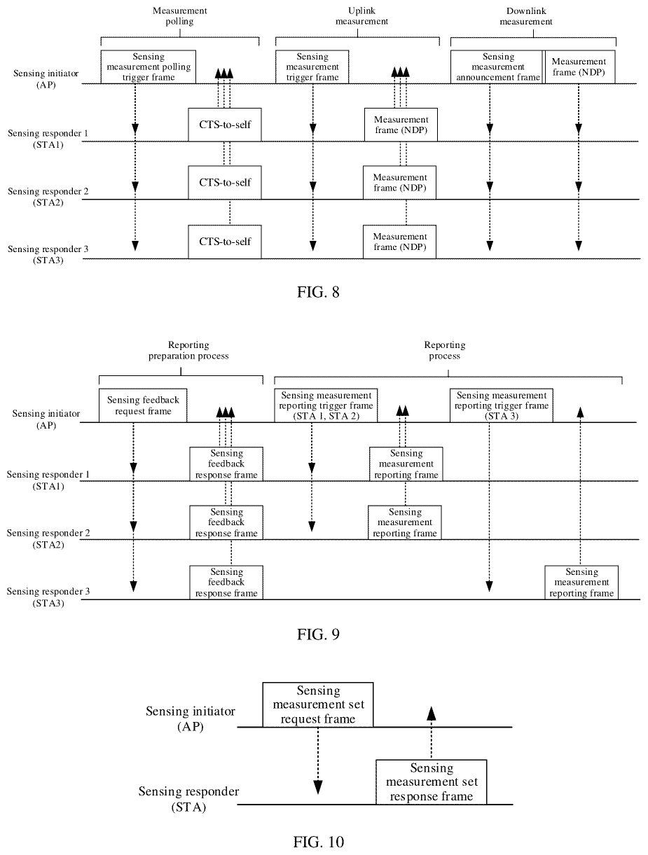

FIGS. 7 to 9 illustrate a trigger-based measurement process, which includes three phases: a sensing measurement setup phase (as shown in FIG. 7), a sensing measurement phase (as shown in FIG. 8), and a sensing measurement reporting phase (as shown in FIG. 9).

In the sensing measurement setup phase, a sensing initiator (e.g., an AP) transmits an MS request frame to a sensing responder 1 (e.g., STA 1), a sensing responder 2 (e.g., STA 2), and a sensing responder 3 (e.g., STA 3), respectively. Each of the sensing responder 1, the sensing responder 2, and the sensing responder 3 feeds back an MS response frame to the sensing initiator.

The sensing measurement phase is divided into three parts: measurement polling, uplink measurement, and downlink measurement.

In the measurement polling process, the sensing initiator transmits a sensing measurement polling trigger frame to the sensing responder 1, the sensing responder 2, and the sensing responder 3, respectively. The sensing responder 1, the sensing responder 2, and the sensing responder 3 each respond to the sensing initiator in response to the sensing measurement polling trigger frame.

In the uplink measurement process, the sensing initiator transmits a sensing measurement trigger frame to the sensing responder 1, the sensing responder 2, and the sensing responder 3, respectively. The sensing responder 1, the sensing responder 2, and the sensing responder 3 each transmit a measurement frame (e.g., an NDP) to the sensing initiator.

In the downlink measurement process, the sensing initiator transmits a sensing measurement announcement frame to the sensing responder 1, the sensing responder 2, and the sensing responder 3, respectively, and then transmits a measurement frame (e.g., an NDP) to the sensing responder 1, the sensing responder 2, and the sensing responder 3, respectively. The CTS-to-self in FIG. 8 is a frame format defined in the related communication standard and is used to represent a response sensing polling trigger frame in the present disclosure.

The sensing measurement reporting phase is divided into two parts: a reporting preparation process and a reporting process.

In the reporting preparation process, the sensing initiator transmits a sensing feedback request frame to the sensing responder 1, the sensing responder 2, and the sensing responder 3, respectively. The sensing responder 1, the sensing responder 2, and the sensing responder 3 feed back sensing feedback response frames to the sensing initiator.

In the reporting process, the sensing initiator transmits a sensing measurement reporting trigger frame to the sensing responder 1 and the sensing responder 2, respectively. The sensing responder 1 and the sensing responder 2 feed back sensing measurement reporting frames to the sensing initiator. The sensing initiator transmits a sensing measurement reporting trigger frame to the sensing responder 3, and the sensing responder 3 feeds back a sensing measurement reporting frame to the sensing initiator.

### Non-TB Sensing Measurement Process:

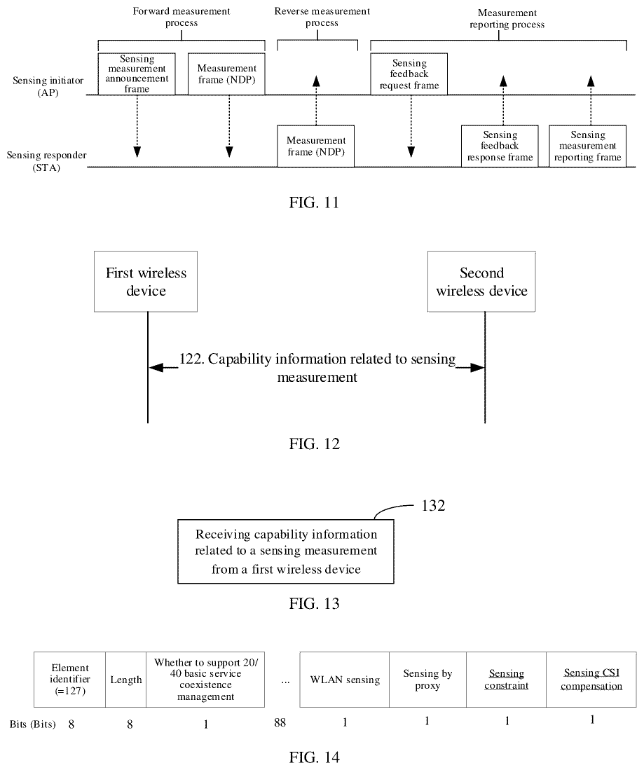

FIGS. 10 to 11 illustrate a non-TB measurement process, which includes two phases: a sensing measurement setup phase (as shown in FIG. 10) and a sensing measurement reporting phase (as shown in FIG. 11).

In the sensing measurement setup phase, a sensing initiator (e.g., an AP) transmits an MS request frame to a sensing responder (e.g., an STA), and the sensing responder feeds back an MS response frame to the sensing initiator.

The sensing measurement reporting phase is divided into 3 parts: a forward measurement process, a reverse measurement process, and a measurement reporting process.

In the forward measurement process, the sensing initiator transmits a sensing measurement announcement frame to the sensing responder, and then transmits a measurement frame (e.g., an NDP) to the sensing responder.

In the reverse measurement process, the sensing responder transmits a measurement frame (e.g., an NDP) to the sensing initiator.

In the measurement reporting process, the sensing initiator transmits a sensing feedback request frame to the sensing responder, the sensing responder transmits a sensing feedback response frame to the sensing initiator, and then the sensing responder transmits a sensing measurement reporting frame to the sensing initiator.

The sensing measurement includes two sensing measurement types: TB and non-TB. In the two sensing measurement types, the roles undertaken by the AP and the STA are different, and thus the respective sensing capabilities required by the AP and the STA are different. For example, in TB sensing, the AP is required to function as a sensing initiator, and the STA is required to function as a sensing responder; in non-TB sensing, the AP is required to function as a sensing responder, and the STA is required to function as a sensing initiator. However, in the design of the Sensing Capabilities element in the related art, different device types and different sensing measurement types are not clearly distinguished. That is, the sensing capability that a device needs to support is not bound to the type of the device and the type of the sensing measurement. This may lead to a mismatch between the sensing capabilities of some devices and their device types and sensing measurement types, resulting in a failure to establish a sensing measurement between some devices.

Based on the above problems, the present disclosure newly defines or adds capability information related to the sensing measurement that needs to be passed by a device for sensing measurement during capability interaction.

In some embodiments, in the case that the device for sensing measurement supports sensing measurements, at least one of a TB sensing measurement type and a non-TB sensing measurement type must be supported.

In the case that the AP supports the TB sensing measurement type, the AP is required to function as a sensing receiver. In the case that the STA supports the TB sensing measurement type, the STA is required to function as a sensing transmitter.

In the case that the AP supports the non-TB sensing measurement type, the AP is required to function as a sensing transmitter. In the case that the STA supports the non-TB sensing measurement type, the STA is required to function as a sensing receiver.

FIG. 12 illustrates a flowchart of a method for transmitting capability information according to some exemplary embodiments of the present disclosure. Description is given based on an example in which the method is applicable to a first wireless device. The method includes at least part of the following processes.

In process 122, a first wireless device transmits capability information related to a sensing measurement to a second wireless device.

The first wireless device and/or the second wireless device are devices participating in the sensing measurement, or devices negotiating the sensing measurement, or devices desiring/preparing for the sensing measurement.

The capability information related to the sensing measurement includes at least one of capability information of a first granularity or capability information of a second granularity. The first granularity is greater than the second granularity.

In some embodiments, the capability information of the first granularity includes general sensing capability information, and the capability information of the second granularity includes specific sensing capability information. In some embodiments, the capability information of the first granularity includes target information. The target information is the capability information used to eliminate or compensate for the impact on the sensing measurement result caused by changes in at least one of: a transmit power of a measurement frame, a receive automatic gain control (AGC) gain of the measurement frame, a transmit antenna radiation pattern of the measurement frame, or a receive antenna radiation pattern of the measurement frame. The capability information of the second granularity includes information of a finer granularity, which belongs to the capability information of the first granularity.

In some embodiments, the capability information of the first granularity is used to indicate whether the first wireless device supports a coarser granularity capability related to the sensing measurement, which includes at least one of:
an information item indicating whether to support a sensing measurement procedure: in short, whether to support sensing, which is used to indicate whether a device supports the sensing measurement procedure, for example, a sensing measurement procedure defined by IEEE 802.11 bf or sensing measurement procedures defined by other wireless communication protocols.
an information item indicating whether to support a sensing-by-proxy measurement procedure: in short, whether to support sensing by proxy, which is used to indicate whether an STA supports requesting an AP to perform a sensing task on its behalf or whether an AP supports receiving a request from an STA to perform a sensing task on behalf of the STA.
an information item indicating whether to support a sensing constraint: the sensing constraint refers to a constraint on a target parameter of a measurement frame in the sensing measurement procedure.
an information item indicating whether to support a sensing compensation: the sensing compensation refers to a compensation for the impact of a change in the target parameter of the measurement frame on a sensing measurement result in the sensing measurement procedure.

The target parameter of the measurement frame include at least one of: a transmit power of the measurement frame, a receive AGC gain of the measurement frame, a transmit antenna radiation pattern of the measurement frame, or a receive antenna radiation pattern of the measurement frame.

In some embodiments, the capability information of the first granularity is carried over at least one of the following frames for transmission:
a beacon frame;
a probe request frame;
a probe response frame;
an association request frame;
an association response frame;
a reassociation request frame;
a reassociation response frame; or
a measurement setup query frame.

In some embodiments, the capability information of the second granularity indicates whether the first wireless device supports a finer granularity capability related to the sensing measurement, which includes at least one of the following information items.

An information item indicating whether the first wireless device supports a TB sensing measurement type. Exemplarily, the TB sensing measurement type is as shown in the above FIGS. 5 to 9.

The information item belongs to the finer granularity information of “whether to support a sensing measurement procedure” in the capability information of the first granularity.

An information item indicating whether the first wireless device supports an optional TB sensing measurement role.

The TB sensing measurement role includes at least one of a sensing initiator, a sensing responder, a sensing transmitter, a sensing receiver, a sensing-by-proxy initiator, or a sensing-by-proxy responder. Alternatively, the TB sensing measurement role includes at least one of a sensing initiator device, a sensing response device, a sensing transmitter device, a sensing receiver device, a sensing-by-proxy initiator device, and a sensing-by-proxy response device.

The optional TB sensing measurement role refers to other sensing measurement roles supported by the device for sensing measurement in addition to the inherent sensing measurement roles. For example, a device for sensing measurement, in addition to supporting the inherent role of a sensing initiator, also supports at least one optional role among a sensing receiver, a sensing responder, a sensing transmitter, a sensing-by-proxy initiator, or a sensing-by-proxy responder. Alternatively, a device for sensing measurement, in addition to supporting the inherent role of a sensing receiver, also supports at least one optional role among a sensing initiator, a sensing responder, a sensing transmitter, a sensing-by-proxy initiator, or a sensing-by-proxy responder.

The information item belongs to the finer granularity information of “whether to support a sensing measurement procedure” and/or “whether to support a sensing-by-proxy measurement procedure” in the capability information of the first granularity.

An information item indicating whether the first wireless device supports a non-TB sensing measurement type.

Exemplarily, the non-TB sensing measurement type is as shown in FIGS. 10 to 11 and includes a sensing measurement setup phase and a sensing measurement reporting phase.

The information item belongs to the finer granularity information of “whether to support a sensing measurement procedure” in the capability information of the first granularity.

An information item indicating whether the first wireless device supports an optional non-TB sensing measurement role.

The non-TB sensing measurement role includes at least one of a sensing initiator, a sensing responder, a sensing transmitter, a sensing receiver, a sensing-by-proxy initiator, or a sensing-by-proxy responder.

Alternatively, the optional non-TB sensing measurement role refers to other sensing measurement roles supported by the device for sensing measurement in addition to the inherent sensing measurement roles. For example, a device for sensing measurement, in addition to supporting the inherent role of a sensing initiator, also supports at least one optional role among a sensing receiver, a sensing responder, a sensing transmitter, a sensing-by-proxy initiator, or a sensing-by-proxy responder. Alternatively, a device for sensing measurement, in addition to supporting the inherent role of a sensing receiver, also supports at least one optional role among a sensing initiator, a sensing responder, a sensing transmitter, a sensing-by-proxy initiator, or a sensing-by-proxy responder.

The information item belongs to the finer granularity information of “whether to support a sensing measurement procedure” and/or “whether to support a sensing-by-proxy measurement procedure” in the capability information of the first granularity.

An information item indicating whether the first wireless device supports a first threshold-based sensing measurement and sensing reporting procedure.

The information item is used to indicate an optional sensing measurement and sensing reporting mechanism. Exemplarily, in the case that a difference between a result of one sensing measurement and a result of a previous sensing measurement is greater than the first threshold, the first wireless device transmits a sensing measurement reporting frame. In the case that a difference between a result of one sensing measurement and a result of a previous sensing measurement is not greater than the first threshold, the first wireless device does not transmit a sensing measurement reporting frame. The information item is beneficial for reducing the waste of resource consumption required for sensing reporting. In some embodiments, the first threshold is predefined, or preconfigured, or configured by a network device/second wireless device for the first wireless device, or autonomously determined by the first wireless device.

The information item belongs to the finer granularity information of “whether to support a sensing measurement procedure” in the capability information of the first granularity.

An information item indicating whether the first wireless device, when functioning as a sensing receiver, supports transmitting a sensing measurement reporting frame to report a sensing measurement result.

The information item belongs to the finer granularity information of “whether to support a sensing measurement procedure” and/or “whether to support a sensing-by-proxy measurement procedure” in the capability information of the first granularity.

An information item indicating whether the first wireless device supports reporting an aggregated sensing measurement result as a sensing initiator.

The aggregated sensing measurement result refers to a measurement result obtained by aggregating measurement results of at least two measurement frames.

In the case that the first wireless device serves as a sensing initiator, the at least two measurement frames are transmitted to the same sensing responder or different sensing responders.

The information item belongs to the finer granularity information of “whether to support a sensing measurement procedure” and/or “whether to support a sensing-by-proxy measurement procedure” in the capability information of the first granularity.

An information item indicating whether the first wireless device supports reporting an aggregated sensing measurement result as a sensing receiver.

In the case that the first wireless device serves as a sensing receiver, the at least two measurement frames are from the same sensing initiator or different sensing initiators.

The information item belongs to the finer granularity information of “whether to support a sensing measurement procedure” and/or “whether to support a sensing-by-proxy measurement procedure” in the capability information of the first granularity.

An information item indicating whether the first wireless device supports maintaining a power for transmitting a measurement frame unchanged or undergoing a change less than a second threshold in a sensing measurement setup.

The second threshold is predefined, or preconfigured, or configured by a network device/second wireless device for the first wireless device, or autonomously determined by the first wireless device.

The information item belongs to the finer granularity information of “whether to support a sensing constraint” and/or “whether to support a sensing compensation” in the capability information of the first granularity.

An information item indicating whether the first wireless device supports maintaining an AGC gain of receiving a measurement frame unchanged or undergoing a change less than a third threshold in a sensing measurement setup.

The third threshold is predefined, or preconfigured, or configured by a network device/second wireless device for the first wireless device, or autonomously determined by the first wireless device.

The information item belongs to the finer granularity information of “whether to support a sensing constraint” and/or “whether to support a sensing compensation” in the capability information of the first granularity.

An information item indicating whether the first wireless device supports maintaining a transmit antenna radiation pattern of a measurement frame transmission unchanged or undergoing a change less than a fourth threshold in a sensing measurement setup.

The fourth threshold is predefined, or preconfigured, or configured by a network device/second wireless device for the first wireless device, or autonomously determined by the first wireless device.

The information item belongs to the finer granularity information of “whether to support a sensing constraint” and/or “whether to support a sensing compensation” in the capability information of the first granularity.

An information item indicating whether the first wireless device supports maintaining a receive antenna radiation pattern for receiving a measurement frame unchanged or undergoing a change less than a fifth threshold in a sensing measurement setup.

The fifth threshold is predefined, or preconfigured, or configured by a network device/second wireless device for the first wireless device, or autonomously determined by the first wireless device.

The information item belongs to the finer granularity information of “whether to support a sensing constraint” and/or “whether to support a sensing compensation” in the capability information of the first granularity.

An information item indicating whether the first wireless device supports compensating for a channel state information (CSI) report received by the first wireless device based on a power for transmitting a measurement frame by the first wireless device itself.

The information item belongs to the finer granularity information of “whether to support a sensing compensation” in the capability information of the first granularity.

An information item indicating whether the first wireless device supports compensating for CSI calculated by the first wireless device based on a power for transmitting a measurement frame by the second wireless device.

The information item belongs to the finer granularity information of “whether to support a sensing compensation” in the capability information of the first granularity.

An information item indicating whether the first wireless device supports compensating for a CSI report received by the first wireless device based on an AGC gain fed back by the second wireless device.

The information item belongs to the finer granularity information of “whether to support a sensing compensation” in the capability information of the first granularity.

An information item indicating whether the first wireless device supports compensating for CSI calculated by the first wireless device based on an AGC gain from receiving a measurement frame by the first wireless device.

The information item belongs to the finer granularity information of “whether to support a sensing compensation” in the capability information of the first granularity.

An information item indicating whether the first wireless device supports feeding back an AGC gain from receiving a measurement frame by the first wireless device to the second wireless device.

The information item belongs to the finer granularity information of “whether to support a sensing measurement procedure” in the capability information of the first granularity.

In some embodiments, the capability information of the second granularity is carried over at least one of the following frames for transmission:
a beacon frame;
a probe request frame;
a probe response frame;
an association request frame;
an association response frame;
a reassociation request frame;
a reassociation response frame; or
a measurement setup query frame.

In some embodiments, the capability information of the first granularity and the capability information of the second granularity are carried over the same frame, and the capability information of the first granularity includes an information item indicating that the sensing measurement procedure is supported.

In the present disclosure, in the case that the first wireless device and the second wireless device both support WLAN sensing, the first wireless device supports at least one of the TB sensing measurement type or the non-TB sensing measurement type, and the second wireless device supports at least one of the TB sensing measurement type or the non-TB sensing measurement type.

In some embodiments, the first wireless device is an AP and the second wireless device is an STA; and/or the first wireless device is an STA and the second wireless device is an AP.

In some embodiments, in the case that the AP supports the TB sensing measurement type, the AP functions as a sensing receiver; and in the case that the STA supports the TB sensing measurement type, the STA functions as a sensing transmitter.

In some embodiments, in the case that the AP supports the non-TB sensing measurement type, the AP functions as a sensing transmitter; and in the case that the STA supports the non-TB sensing measurement type, the STA functions as a sensing receiver.

In summary, in the method for transmitting capability information according to the embodiments, based on interaction of capability information related to the sensing measurement between the devices for sensing measurement, the success rate of establishing a sensing measurement between devices for sensing measurement is improved.

In the method according to the embodiments, by indicating, in the capability information of the first granularity, information related to whether to support sensing measurement procedure, the sensing by proxy, the sensing constraint, and the sensing compensation, the sensing capability information interaction between the devices for sensing measurement is more comprehensive and concise. In addition, in the case that the two sides support the capability of sensing constraints, the control of sensing constraints is introduced in the sensing measurement procedure; and/or in the case that the two sides support the capability of the sensing compensation, the control of sensing compensation is introduced in the sensing measurement procedure, such that the accuracy of the sensing measurement result is improved and the impact of changes in the target parameter on the sensing measurement is eliminated.

In the method according to the embodiments, by indicating, in the capability information of the second granularity, information related to whether to support the sensing measurement procedure, the sensing by proxy, the sensing constraint, and the sensing compensation using finer granularity information items, the sensing capability information interaction between the devices for sensing measurement is more comprehensive and accurate.

FIG. 13 illustrates a method for receiving capability information according to some exemplary embodiments of the present disclosure. Description is given based on an example in which the method is applicable to a second wireless device. The method includes at least part of the following processes.

In process 132, the second wireless device receives capability information related to a sensing measurement from a first wireless device.

The first wireless device and/or the second wireless device are devices participating in the sensing measurement, or devices negotiating the sensing measurement, or devices desiring/preparing for the sensing measurement.

The capability information related to the sensing measurement includes at least one of capability information of a first granularity or capability information of a second granularity. The first granularity is greater than the second granularity.

In some embodiments, the capability information of the first granularity includes general sensing capability information, and the capability information of the second granularity includes specific sensing capability information. The capability information of the first granularity includes target information. The target information is used to eliminate or compensate for the impact on the sensing measurement result caused by changes in at least one of: a transmit power of a measurement frame, a receive automatic gain control (AGC) gain of the measurement frame, a transmit antenna radiation pattern of the measurement frame, or a receive antenna radiation pattern of the measurement frame. The capability information of the second granularity includes information of a finer granularity, which belongs to the capability information of the first granularity.

In some embodiments, the capability information of the first granularity indicates whether the first wireless device supports a coarser granularity capability related to the sensing measurement, which includes at least one of:
an information item indicating whether to support a sensing measurement procedure: in short, whether to support sensing, which is used to indicate whether a device supports the sensing measurement procedure, for example, a sensing measurement procedure defined by IEEE 802.1 lbf or sensing measurement procedures defined by other wireless communication protocols;
an information item indicating whether to support a sensing-by-proxy measurement procedure: in short, whether to support sensing by proxy, which is used to indicate whether an STA supports requesting an AP to perform a sensing task on its behalf or whether an AP supports receiving a request from an STA to perform a sensing task on behalf of the STA;
an information item indicating whether to support a sensing constraint: the sensing constraint refers to a constraint on a target parameter of a measurement frame in the sensing measurement procedure; or
an information item indicating whether to support a sensing compensation: the sensing compensation refers to a compensation for the impact of a change in the target parameter of the measurement frame on a sensing measurement result in the sensing measurement procedure.

The target parameter of the measurement frame include at least one of: a transmit power of the measurement frame, a receive AGC gain of the measurement frame, a transmit antenna radiation pattern of the measurement frame, or a receive antenna radiation pattern of the measurement frame.

In some embodiments, the capability information of the first granularity is carried over at least one of the following frames for transmission:
a beacon frame;
a probe request frame;
a probe response frame;
an association request frame;
an association response frame;
a reassociation request frame;
a reassociation response frame; or
a measurement setup query frame.

In some embodiments, the capability information of the second granularity indicates whether the first wireless device supports a finer granularity capability related to the sensing measurement, which includes at least one of the following information items.

An information item indicating whether the first wireless device supports a TB sensing measurement type.

Exemplarily, the TB sensing measurement type is as shown in FIGS. 5 to 9.

The information item belongs to the finer granularity information of “whether to support a sensing measurement procedure” in the capability information of the first granularity.

An information item indicating whether the first wireless device supports an optional TB sensing measurement role.

The TB sensing measurement role includes at least one of a sensing initiator, a sensing responder, a sensing transmitter, a sensing receiver, a sensing-by-proxy initiator, or a sensing-by-proxy responder.

Alternatively, the TB sensing measurement role refers to other sensing measurement roles supported by the device for sensing measurement in addition to the inherent sensing measurement roles. For example, a device for sensing measurement, in addition to supporting the inherent role of a sensing initiator, also supports at least one optional role among a sensing receiver, a sensing responder, a sensing transmitter, a sensing-by-proxy initiator, or a sensing-by-proxy responder. Alternatively, a device for sensing measurement, in addition to supporting the inherent role of a sensing receiver, also supports at least one optional role among a sensing initiator, a sensing responder, a sensing transmitter, a sensing-by-proxy initiator, or a sensing-by-proxy responder.

The information item belongs to the finer granularity information of “whether to support a sensing measurement procedure” and/or “whether to support a sensing-by-proxy measurement procedure” in the capability information of the first granularity.

An information item indicating whether the first wireless device supports a non-TB sensing measurement type. Exemplarily, the non-TB sensing measurement type is as shown in FIGS. 10 to 11 and includes a sensing measurement setup phase and a sensing measurement reporting phase.

The information item belongs to the finer granularity information of “whether to support a sensing measurement procedure” in the capability information of the first granularity.

An information item indicating whether the first wireless device supports an optional non-TB sensing measurement role.

The non-TB sensing measurement role includes at least one of a sensing initiator, a sensing responder, a sensing transmitter, a sensing receiver, a sensing-by-proxy initiator, or a sensing-by-proxy responder.

Alternatively, the optional non-TB sensing measurement role refers to other sensing measurement roles supported by the device for sensing measurement in addition to the inherent sensing measurement roles. For example, a device for sensing measurement, in addition to supporting the inherent role of a sensing initiator, also supports at least one optional role among a sensing receiver, a sensing responder, a sensing transmitter, a sensing-by-proxy initiator, or a sensing-by-proxy responder. Alternatively, a device for sensing measurement, in addition to supporting the inherent role of a sensing receiver, also supports at least one optional role among a sensing initiator, a sensing responder, a sensing transmitter, a sensing-by-proxy initiator, or a sensing-by-proxy responder. The information item belongs to the finer granularity information of “whether to support a sensing measurement procedure” and/or “whether to support a sensing-by-proxy measurement procedure” in the capability information of the first granularity.

An information item indicating whether the first wireless device supports a first threshold-based sensing measurement and sensing reporting procedure.

The information item belongs to the finer granularity information of “whether to support a sensing measurement procedure” in the capability information of the first granularity.

An information item indicating whether the first wireless device, when functioning as a sensing receiver, supports transmitting a sensing measurement reporting frame to report a sensing measurement result.

The information item belongs to the finer granularity information of “whether to support a sensing measurement procedure” and/or “whether to support a sensing-by-proxy measurement procedure” in the capability information of the first granularity.

An information item indicating whether the first wireless device supports reporting an aggregated sensing measurement result as a sensing initiator.

The aggregated sensing measurement result refers to a measurement result obtained by aggregating measurement results of at least two measurement frames.

In the case that the first wireless device serves as a sensing initiator, the at least two measurement frames are transmitted to the same sensing responder or different sensing responders.

The information item belongs to the finer granularity information of “whether to support a sensing measurement procedure” and/or “whether to support a sensing-by-proxy measurement procedure” in the capability information of the first granularity.

An information item indicating whether the first wireless device supports reporting an aggregated sensing measurement result as a sensing receiver.

In the case that the first wireless device serves as a sensing receiver, the at least two measurement frames are from the same sensing initiator or different sensing initiators.

The information item belongs to the finer granularity information of “whether to support a sensing measurement procedure” and/or “whether to support a sensing-by-proxy measurement procedure” in the capability information of the first granularity.

An information item indicating whether the first wireless device supports maintaining a power for transmitting a measurement frame unchanged or undergoing a change less than a second threshold in a sensing measurement setup.

The second threshold is predefined, or preconfigured, or configured by a network device/second wireless device for the first wireless device, or autonomously determined by the first wireless device.

The information item belongs to the finer granularity information of “whether to support a sensing constraint” and/or “whether to support a sensing compensation” in the capability information of the first granularity.

An information item indicating whether the first wireless device supports maintaining an AGC gain of receiving a measurement frame unchanged or undergoing a change less than a third threshold in a sensing measurement setup.

The third threshold is predefined, or preconfigured, or configured by a network device/second wireless device for the first wireless device, or autonomously determined by the first wireless device.

The information item belongs to the finer granularity information of “whether to support a sensing constraint” and/or “whether to support a sensing compensation” in the capability information of the first granularity.

An information item indicating whether the first wireless device supports maintaining a transmit antenna radiation pattern of a measurement frame transmission unchanged or undergoing a change less than a fourth threshold in a sensing measurement setup.

The fourth threshold is predefined, or preconfigured, or configured by a network device/second wireless device for the first wireless device, or autonomously determined by the first wireless device.

The information item belongs to the finer granularity information of “whether to support a sensing constraint” and/or “whether to support a sensing compensation” in the capability information of the first granularity.

An information item indicating whether the first wireless device supports maintaining a receive antenna radiation pattern for receiving a measurement frame unchanged or undergoing a change less than a fifth threshold in a sensing measurement setup.

The fifth threshold is predefined, or preconfigured, or configured by a network device/second wireless device for the first wireless device, or autonomously determined by the first wireless device.

The information item belongs to the finer granularity information of “whether to support a sensing constraint” and/or “whether to support a sensing compensation” in the capability information of the first granularity.

An information item indicating whether the first wireless device supports compensating for a CSI report received by the first wireless device based on a power for transmitting a measurement frame by the first wireless device.

The information item belongs to the finer granularity information of “whether to support a sensing compensation” in the capability information of the first granularity.

An information item indicating whether the first wireless device supports compensating for CSI calculated by the first wireless device based on a power for transmitting a measurement frame by the second wireless device.

The information item belongs to the finer granularity information of “whether to support a sensing compensation” in the capability information of the first granularity.

An information item indicating whether the first wireless device supports compensating for a CSI report received by the first wireless device based on an AGC gain fed back by the second wireless device.

The information item belongs to the finer granularity information of “whether to support a sensing compensation” in the capability information of the first granularity.

An information item indicating whether the first wireless device supports compensating for CSI calculated by the first wireless device based on an AGC gain from receiving a measurement frame by the first wireless device.

The information item belongs to the finer granularity information of “whether to support a sensing compensation” in the capability information of the first granularity.

An information item indicating whether the first wireless device supports feeding back an AGC gain from receiving a measurement frame by the first wireless device to the second wireless device.

The information item belongs to the finer granularity information of “whether to support a sensing measurement procedure” in the capability information of the first granularity.

In some embodiments, the capability information of the second granularity is carried over at least one of the following frames for transmission:
a beacon frame;
a probe request frame;
a probe response frame;
an association request frame;
an association response frame;
a reassociation request frame;
a reassociation response frame; or
a measurement setup query frame.

In some embodiments, the capability information of the first granularity and the capability information of the second granularity are carried over the same frame, and the capability information of the first granularity includes an information item indicating that the sensing measurement procedure is supported.

In the present disclosure, in the case that the first wireless device and the second wireless device both support WLAN sensing, the first wireless device supports at least one of the TB sensing measurement type or the non-TB sensing measurement type, and the second wireless device supports at least one of the TB sensing measurement type or the non-TB sensing measurement type.

In some embodiments, the first wireless device is an AP and the second wireless device is an STA; and/or the first wireless device is an STA and the second wireless device is an AP.

In some embodiments, in the case that the AP supports the TB sensing measurement type, the AP functions as a sensing receiver; and in the case that the STA supports the TB sensing measurement type, the STA functions as a sensing transmitter.

In some embodiments, in the case that the AP supports the non-TB sensing measurement type, the AP functions as a sensing transmitter; and in the case that the STA supports the non-TB sensing measurement type, the STA functions as a sensing receiver.

In summary, in the method for receiving capability information according to the embodiments, based on interaction of capability information related to the sensing measurement between the devices for sensing measurement, the success rate of establishing a sensing measurement between devices for sensing measurement is improved.

In the method according to the embodiments, by indicating, in the capability information of the first granularity, information related to whether to support sensing measurement procedure, the sensing by proxy, the sensing constraint, and the sensing compensation, the sensing capability information interaction between the devices for sensing measurement is more comprehensive and concise. In addition, in the case that the two sides support the capability of sensing constraints, the control of sensing constraints is introduced in the sensing measurement procedure; and/or in the case that the two sides support the capability of the sensing compensation, the control of sensing compensation is introduced in the sensing measurement procedure, such that the accuracy of the sensing measurement result is improved and the impact of changes in the target parameter on the sensing measurement is eliminated.

In the method according to the embodiments, by indicating, in the capability information of the second granularity, information related to whether to support the sensing measurement procedure, the sensing by proxy, the sensing constraint, and the sensing compensation using finer granularity information items, the sensing capability information interaction between the devices for sensing measurement is more comprehensive and accurate.

Cases where the capability information related to the sensing measurement includes capability information of a first granularity:

In some embodiments, the capability information related to the sensing measurement includes capability information of a first granularity, wherein the capability information of the first granularity is carried over an Extended Capabilities element.

In some embodiments, as shown in FIG. 14, two fields related to sensing measurement capability (as shown in the underlined text) are added to the existing Extended Capabilities element in the present disclosure.

Element identifier (ID): This field takes a value of 127, and indicates that the element is a first type element. In some embodiments, the first type element is an Extended Capabilities element.

Length: a value thereof is the number of bytes of the first type element excluding the Element ID field and the Length field.

Whether to support the 20/40 basic service coexistence management: This field indicates whether the device supports 20/40 basic service coexistence management. Exemplarily, “0” indicates that the 20/40 basic service coexistence management is not supported, and “1” indicates that the 20/40 basic service coexistence management is supported. Alternatively, “0” indicates that the 20/40 basic service coexistence management is supported, and “1” indicates that the 20/40 basic service coexistence management is not supported.

WLAN sensing: This field indicates whether the device supports a sensing measurement procedure defined by 802.1 lbf. Exemplarily, “0” indicates that the sensing measurement procedure defined by 802.1 lbf is not supported, and “1” indicates that the sensing measurement procedure defined by 802.1 lbf is supported. Alternatively, “0” indicates that the sensing measurement procedure defined by 802.1 lbf is supported, and “1” indicates that the sensing measurement procedure defined by 802.1 lbf is not supported.

Sensing by proxy (SBP): This field indicates whether the device supports requesting an AP to perform WLAN sensing on its behalf or whether the device supports receiving a request from an STA to perform WLAN sensing on behalf of the STA. Exemplarily, “0” indicates that the sensing by proxy is not supported, and “1” indicates that the sensing by proxy is supported. Alternatively, “0” indicates that the sensing by proxy is supported, and “1” indicates that the sensing by proxy is not supported.

Sensing constraint: This field indicates whether the device supports constraining a transmit power of an NDP, constraining a receive AGC gain of the NDP, constraining a transmission (radiation) antenna pattern, or constraining an NDP receive antenna pattern in the sensing measurement. Exemplarily, “0” indicates that the sensing constraint is not supported, and “1” indicates that the sensing constraint is supported. Alternatively, “0” indicates that the sensing constraint is supported, and “1” indicates that the sensing constraint is not supported.

Sensing CSI compensation: This field indicates whether the device supports compensating for the impact of changes in a transmit power of an NDP, an AGC gain, a transmit antenna radiation pattern, or a receive antenna radiation pattern on a CSI measurement result. Exemplarily, “0” indicates that the sensing CSI compensation is not supported, and “1” indicates that the sensing CSI compensation is supported. Alternatively, “0” indicates that the sensing CSI compensation is supported, and “1” indicates that the sensing CSI compensation is not supported.

In some embodiments, the capability information of the first granularity is carried over the first type element of the frame, and each capability information item of the first granularity as described above occupies one field in the first type element.

Cases where the capability information related to the sensing measurement includes capability information of a second granularity:

In some embodiments, as shown in FIG. 15, the capability information related to the sensing measurement includes capability information of a second granularity, and the capability information of the second granularity is carried over a Sensing Capabilities element.

Element ID: This field takes a value of 255, and indicates that the element is a second type element. In some embodiments, the second type element is a Sensing Capabilities element, and the Sensing Capabilities element is an extended element.

Length: A value of this field is the number of bytes of the second type capabilities element excluding the Element ID field and the Length field.

Element ID extension: This field takes a value of 99 (any numerical value ranging from 94 to 255 is available), and indicates that the element is a Sensing Capabilities element.

TB sensing measurement: This field indicates whether the device supports a TB sensing measurement type. Exemplarily, “0” indicates that the TB sensing measurement is not supported, and “1” indicates that the TB sensing measurement is supported. Alternatively, “0” indicates that the TB sensing measurement is supported, and “1” indicates that the TB sensing measurement is not supported.

In some embodiments, in the case that the field “non-TB sensing measurement” takes a value of “0”, the field “TB sensing measurement” must take a value of “1”; and in the case that the field “non-TB sensing measurement” takes a value of “1”, the field “TB sensing measurement” takes a value of “0” or “1”.

TB sensing measurement role: This field indicates whether the device supports optional TB sensing measurement roles. Exemplarily, the field has different meanings when a device is an AP or an STA. The specific values and their meanings are shown in Table 1. In the case that the field “TB sensing measurement” takes a value of 0, the field “TB sensing measurement role” is reserved.

TABLE 1
TB sensing measurement roles

| AP | | STA | |
|---|---|---|---|
| Value | Meaning | Value | Meaning |
| 0 | Incapable of functioning as | 0 | Incapable of functioning as |
| | a sensing transmitter | | a sensing receiver |
| 1 | Capable of functioning as a | 1 | Capable of functioning as a |
| | sensing transmitter | | sensing receiver |

Non-TB sensing measurement: This field indicates whether the device supports a non-TB sensing measurement type. Exemplarily, “0” indicates that the non-TB sensing measurement is not supported, and “1” indicates that the non-TB sensing measurement is supported. Alternatively, “0” indicates that the non-TB sensing measurement is supported, and “1” indicates that the non-TB sensing measurement is not supported.

In some embodiments, in the case that the field “TB sensing measurement” takes a value of “0”, the field “Non-TB sensing measurement” takes a value of “1”; and in the case that the field “TB sensing measurement” takes a value of “1”, the field “Non-TB sensing measurement” takes a value of “0” or “1”.

Non-TB sensing measurement role: This field indicates whether the device supports optional non-TB sensing measurement roles. Exemplarily, the field has different meanings when a device is an AP or an STA. The specific values and their meanings are shown in Table 2. In the case that the field “non-TB sensing measurement” takes a value of 0, the field “Non-TB sensing measurement role” is reserved.

TABLE 2
Non-TB sensing measurement roles

| AP | | STA | |
|---|---|---|---|
| Value | Meaning | Value | Meaning |
| 0 | Incapable of functioning as | 0 | Incapable of functioning as |
| | a sensing receiver | | a sensing transmitter |
| 1 | Capable of functioning as a | 1 | Capable of functioning as a |
| | sensing receiver | | sensing transmitter |

Whether to support first threshold-based sensing: This field indicates whether the device supports a first threshold-based sensing measurement and sensing reporting procedure. Exemplarily, “0” indicates that the first threshold-based sensing is not supported, and “1” indicates that the first threshold-based sensing is supported. Alternatively, “0” indicates that the first threshold-based sensing is supported, and “1” indicates that the first threshold-based sensing is not supported.

Whether to support a sensing report: This field indicates whether the device, when functioning as a sensing receiver, supports transmitting a sensing measurement reporting frame to report a sensing measurement result. Exemplarily, “0” indicates that the sensing report is not supported, and “1” indicates that the sensing report is supported. Alternatively, “0” indicates that the sensing report is supported, and “1” indicates that the sensing report is not supported.

Whether to support aggregated report as a sensing initiator: This field indicates whether the device supports reporting an aggregated sensing measurement result as a sensing initiator. Exemplarily, “0” indicates that the aggregated report as a sensing initiator is not supported, and “1” indicates that the aggregated report as a sensing initiator is supported. Alternatively, “0” indicates that the aggregated report as a sensing initiator is supported, and “1” indicates that the aggregated report as a sensing initiator is not supported.

Whether to support aggregated report as a sensing receiver: This field indicates whether the device supports reporting an aggregated sensing measurement result as a sensing receiver. Exemplarily, “0” indicates that the aggregated report as a sensing receiver is not supported, and “1” indicates that the aggregated report as a sensing receiver is supported. Alternatively, “0” indicates that the aggregated report as a sensing receiver is supported, and “1” indicates that the aggregated report as a sensing receiver is not supported.

Whether to support a transmit power constraint (Tx power constraint): This field indicates whether the device is capable of maintaining a transmit power of an NDP frame unchanged or undergoing only a minor change in a sensing measurement instance related to a sensing measurement setup. Exemplarily, “0” indicates that the transmit power constraint is not supported, and “1” indicates that the transmit power constraint is supported. Alternatively, “0” indicates that the transmit power constraint is supported, and “1” indicates that the transmit power constraint is not supported.

Whether to support an AGC gain constraint: This field indicates whether the device is capable of maintaining an AGC gain of an NDP reception unchanged or undergoing only a minor change in a sensing measurement instance related to a sensing measurement setup. Exemplarily, “0” indicates that the AGC gain constraint is not supported, and “1” indicates that the AGC gain constraint is supported. Alternatively, “0” indicates that the AGC gain constraint is supported, and “1” indicates that the AGC gain constraint is not supported.

Whether to support a transmit antenna radiation pattern constraint (Tx antenna radiation pattern constraint): the field indicates whether the device is capable of maintaining an antenna radiation pattern for transmitting an NDP unchanged or undergoing only a minor change in a sensing measurement instance related to a sensing measurement setup. The antenna radiation pattern for transmitting the NDP is referred to as the “transmit antenna radiation pattern” for short. Exemplarily, “0” indicates that the transmit antenna radiation pattern constraint is not supported, and “1” indicates that the transmit antenna radiation pattern constraint is supported. Alternatively, “0” indicates that the transmit antenna radiation pattern constraint is supported, and “1” indicates that the transmit antenna radiation pattern constraint is not supported.

Whether to support receive antenna radiation pattern constraint (Rx antenna pattern constraint): v field indicates whether the device is capable of maintaining an antenna radiation pattern for receiving an NDP unchanged or undergoing only a minor change in a sensing measurement instance related to a sensing measurement setup. The antenna radiation pattern for receiving the NDP is referred to as the “receive antenna radiation pattern” for short. Exemplarily, “0” indicates that the receive antenna radiation pattern constraint is not supported, and “1” indicates that the receive antenna radiation pattern constraint is supported. Alternatively, “0” indicates that the receive antenna radiation pattern constraint is supported, and “1” indicates that the receive antenna radiation pattern constraint is not supported.

Whether to support a transmit power CSI compensation as a sensing transmitter (transmitter Tx power CSI compensation): This field indicates whether the device is capable of compensating for a received CSI report based on a power for transmitting an NDP by the device. Exemplarily, “0” indicates that the transmit power CSI compensation as a sensing transmitter is not supported, and “1” indicates that the transmit power CSI compensation as a sensing transmitter is supported. Alternatively, “0” indicates that the transmit power CSI compensation as a sensing transmitter is supported, and “1” indicates that the transmit power CSI compensation as a sensing transmitter is not supported.

Whether to support a transmit power CSI compensation as a sensing receiver (receiver Tx power CSI compensation): This field indicates whether the device is capable of compensating for a calculated CSI based on a power for transmitting an NDP by the other side. Exemplarily, “0” indicates that the transmit power CSI compensation as a sensing receiver is not supported, and “1” indicates that the transmit power CSI compensation as a sensing receiver is supported. Alternatively, “0” indicates that the transmit power CSI compensation as a sensing receiver is supported, and “1” indicates that the transmit power CSI compensation as a sensing receiver is not supported.

Whether to support AGC CSI compensation as a sensing transmitter (transmitter AGC CSI compensation): This field indicates whether the device is capable of compensating for a received CSI report based on an AGC gain fed back by the other side. Exemplarily, “0” indicates that the AGC CSI compensation as a sensing transmitter is not supported, and “1” indicates that the AGC CSI compensation as a sensing transmitter is supported. Alternatively, “0” indicates that the AGC CSI compensation as a sensing transmitter is supported, and “1” indicates that the AGC CSI compensation as a sensing transmitter is not supported.

Whether to support AGC CSI compensation as a sensing receiver (receiver AGC CSI compensation): This field indicates whether the device is capable of compensating for a calculated CSI based on an AGC gain of its own NDP reception. Exemplarily, “0” indicates that the AGC CSI compensation as a sensing receiver is not supported, and “1” indicates that the AGC CSI compensation as a sensing receiver is supported. Alternatively, “0” indicates that the AGC CSI compensation as a sensing receiver is supported, and “1” indicates that the AGC CSI compensation as a sensing receiver is not supported.

Whether to support AGC gain feedback: This field indicates whether the device is capable of feeding back an AGC gain of an NDP reception thereof to a counterpart device. Exemplarily, “0” indicates that the AGC gain feedback is not supported, and “1” indicates that the AGC gain feedback is supported. Alternatively, “0” indicates that the AGC gain feedback is supported, and “1” indicates that the AGC gain feedback is not supported.

Cases where the capability information related to the sensing measurement includes capability information of a first granularity and a second granularity:

In some embodiments, the capability information related to the sensing measurement includes capability information of a first granularity and capability information of a second granularity. The capability information of the first granularity and the capability information of the second granularity are carried over an Extended Capabilities element and a Sensing Capabilities element, respectively. The Extended Capabilities element and the Sensing Capabilities element are as described above.

In some embodiments, in the case that a “WLAN sensing” field of the Extended Capabilities element contained in a management frame indicates that the device does not support WLAN sensing, the Sensing Capabilities element is not contained in the management frame. In the case that the “WLAN sensing” field of the Extended Capabilities element contained in the management frame indicates that the device supports WLAN sensing, the Sensing Capabilities element is contained or not contained in the management frame.

In some embodiments, a first management frame includes an information item indicating that the sensing measurement procedure is not supported, and the first management frame includes the capability information of the first granularity but does not include the capability information of the second granularity; or a second management frame includes an information item indicating that the sensing measurement procedure is supported, and the second management frame includes the capability information of the first granularity, or both the capability information of the first granularity and the capability information of the second granularity.

In summary, according to the design of the Extended Capabilities element and the Sensing Capabilities element in the present disclosure, more comprehensive, accurate, and concise capability information related to the sensing measurement is carried in the information interaction phase of the sensing measurement, such that the sensing capability supported by the device for sensing measurement is bound to the device type of the device for sensing measurement and the type of the sensing measurement, which is beneficial for the device for sensing measurement to indicate the sensing capability thereof, such that the success rate of subsequent sensing measurement establishment is improved.

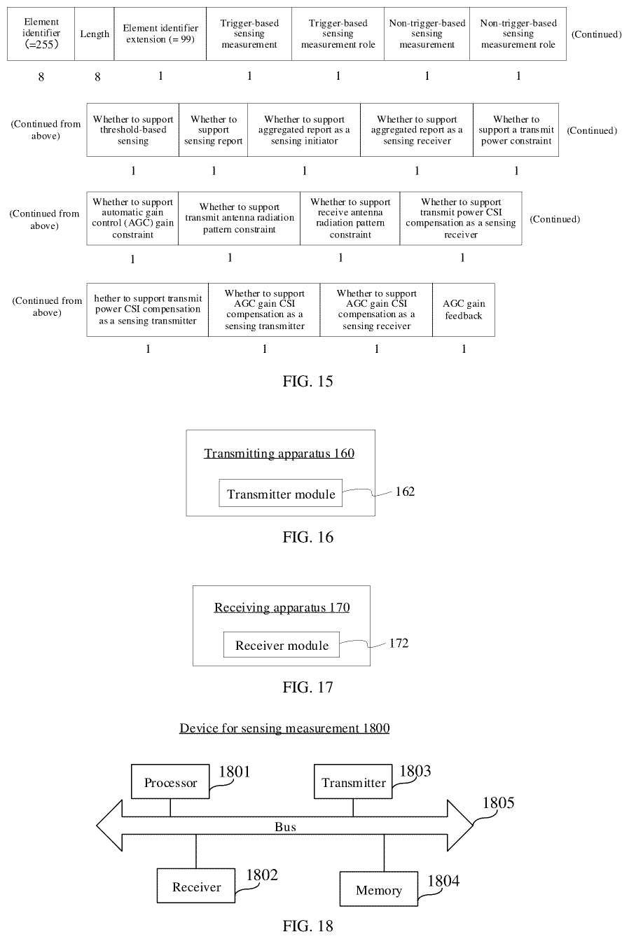

FIG. 16 illustrates a block diagram of an apparatus 160 for transmitting capability information according to some exemplary embodiments of the present disclosure. The apparatus 160 may be implemented as a first wireless device or a component inside the first wireless device. The apparatus 160 includes a transmitter module 162.

The transmitter module 162 is configured to transmit capability information related to a sensing measurement to a second wireless device, wherein the capability information related to the sensing measurement includes at least one of capability information of a first granularity or capability information of a second granularity, wherein the first granularity is greater than the second granularity.

In some embodiments of the present disclosure, the capability information of the first granularity includes at least one of:
an information item indicating whether to support a sensing measurement procedure;
an information item indicating whether to support a sensing-by-proxy measurement procedure;
an information item indicating whether to support a sensing constraint; or
an information item indicating whether to support a sensing compensation.

In some embodiments of the present disclosure, the sensing constraint refers to a constraint on a target parameter of a measurement frame in the sensing measurement procedure.

The sensing compensation refers to a compensation for the impact of a change in the target parameter of the measurement frame on a sensing measurement result in the sensing measurement procedure.

The target parameter of the measurement frame includes at least one of: a transmit power of the measurement frame, a receive AGC gain of the measurement frame, an antenna radiation pattern for transmitting the measurement frame, or an antenna radiation pattern for receiving the measurement frame.

In some embodiments of the present disclosure, the capability information of the first granularity is carried over at least one of:
a beacon frame;
a probe request frame;
a probe response frame;
an association request frame;
an association response frame;
a reassociation request frame;
a reassociation response frame; or
a measurement setup query frame.

In some embodiments of the present disclosure, the capability information of the first granularity is carried over a first type element of the at least one frame, and each of the at least one information item occupies one field in the first type element.

In some embodiments of the present disclosure, the first type element is an Extended Capabilities element.

In some embodiments of the present disclosure, the capability information of the second granularity includes at least one of:
an information item indicating whether the apparatus supports a TB sensing measurement type;
an information item indicating whether the apparatus supports an optional TB sensing measurement role;
an information item indicating whether the apparatus supports a non-TB sensing measurement type;
an information item indicating whether the apparatus supports an optional non-TB sensing measurement role;
an information item indicating whether the apparatus supports a first threshold-based sensing measurement and sensing reporting procedure;
an information item indicating whether the apparatus, when functioning as a sensing receiver, supports transmitting a sensing measurement reporting frame to report a sensing measurement result;
an information item indicating whether the apparatus supports reporting an aggregated sensing measurement result as a sensing initiator;
an information item indicating whether the apparatus supports reporting an aggregated sensing measurement result as a sensing receiver;
an information item indicating whether the apparatus supports maintaining a power for transmitting a measurement frame unchanged or undergoing a second threshold in a sensing measurement setup;
an information item indicating whether the apparatus supports maintaining an AGC gain of receiving the measurement frame unchanged or undergoing a change less than a third threshold in a sensing measurement setup;
an information item indicating whether the apparatus supports maintaining an antenna radiation pattern for transmitting the measurement frame unchanged or undergoing a change less than a fourth threshold in a sensing measurement setup;
an information item indicating whether the apparatus supports maintaining an antenna radiation pattern for receiving the measurement frame unchanged or undergoing a change less than a fifth threshold in a sensing measurement setup;
an information item indicating whether the apparatus supports compensating for a CSI report received by the apparatus based on a power for transmitting the measurement frame by the transmitter module 162;
an information item indicating whether the apparatus supports compensating for CSI calculated by the apparatus based on a power for transmitting the measurement frame by the second wireless device;
an information item indicating whether the apparatus supports compensating for a CSI report received by the apparatus based on an AGC gain fed back by the second wireless device;
an information item indicating whether the apparatus supports compensating for CSI calculated by the apparatus based on an AGC gain of receiving the measurement frame by the apparatus; or
an information item indicating whether the apparatus supports feeding back an AGC gain of receiving the measurement frame by the apparatus to the second wireless device;

In some embodiments of the present disclosure, the capability information of the second granularity is carried over at least one of:
a beacon frame;
a probe request frame;
a probe response frame;
an association request frame;
an association response frame;
a reassociation request frame;
a reassociation response frame; or
a measurement setup query frame.

In some embodiments of the present disclosure, the capability information of the second granularity is carried over a second type element of the at least one frame, and each of the at least one information item occupies one field in the second type element.

In some embodiments of the present disclosure, the second type element is a Sensing Capabilities element.

In some embodiments of the present disclosure, the capability information of the first granularity and the capability information of the second granularity are carried over the same frame.

The capability information of the first granularity includes an information item indicating that the sensing measurement procedure is supported.

In some embodiments of the present disclosure, a first management frame includes an information item indicating that the sensing measurement procedure is not supported, and the first management frame includes the capability information of the first granularity but does not include the capability information of the second granularity; or a second management frame includes an information item indicating that the sensing measurement procedure is supported, and the second management frame includes the capability information of the first granularity, or both the capability information of the first granularity and the capability information of the second granularity.

It should be noted that the above embodiments or technical features may also be combined in pairs or more combinations according to the requirements of those skilled in the art, which are not be described herein any further.

In summary, according to the apparatus for transmitting capability information provided in the embodiments, the success rate of establishing a sensing measurement between devices for sensing measurement is improved by exchanging capability information related to the sensing measurement between the devices for sensing measurement.

The apparatus provided in the embodiments also makes the sensing capability information interaction between the devices for sensing measurement more comprehensive and concise by indicating, in the capability information of the first granularity, information related to whether to support the sensing measurement procedure, the sensing by proxy, the sensing constraint, and the sensing compensation.

The apparatus provided in the embodiments also makes the sensing capability information interaction between the devices for sensing measurement more comprehensive and accurate by indicating, in the capability information of the second granularity, information related to whether to support the sensing measurement procedure, the sensing by proxy, the sensing constraint, and the sensing compensation using finer granularity information items.

FIG. 17 illustrates a block diagram of an apparatus 170 for receiving capability information according to some exemplary embodiments of the present disclosure. The apparatus 170 may be implemented as a second wireless device or a component inside the second wireless device. The apparatus 170 includes:
a receiver module 172, configured to receive capability information related to a sensing measurement from a first wireless device, where the capability information related to the sensing measurement includes at least one of capability information of a first granularity or capability information of a second granularity, wherein the first granularity is greater than the second granularity.

In some embodiments of the present disclosure, the capability information of the first granularity includes at least one of:
an information item indicating whether to support a sensing measurement procedure;
an information item indicating whether to support a sensing-by-proxy measurement procedure;
an information item indicating whether to support a sensing constraint; or
an information item indicating whether to support a sensing compensation.

In some embodiments of the present disclosure, the sensing constraint refers to a constraint on a target parameter of a measurement frame in the sensing measurement procedure.

The sensing compensation refers to a compensation for the impact of a change in the target parameter of the measurement frame on a sensing measurement result in the sensing measurement procedure.

The target parameter of the measurement frame include at least one of: a transmit power of the measurement frame, a receive AGC gain of the measurement frame, a transmit antenna radiation pattern of the measurement frame, or a receive antenna radiation pattern of the measurement frame.

In some embodiments of the present disclosure, the capability information of the first granularity is carried over at least one of:
a beacon frame;
a probe request frame;
a probe response frame;
an association request frame;
an association response frame;
a reassociation request frame;
a reassociation response frame; or
a measurement setup query frame.

In some embodiments of the present disclosure, the capability information of the first granularity is carried over a first type element of the at least one frame, and each of the at least one information item occupies one field in the first type element.

In some embodiments of the present disclosure, the first type element is an Extended Capabilities element.

In some embodiments of the present disclosure, the capability information of the second granularity includes at least one of:
an information item indicating whether the first wireless device supports a TB sensing measurement type;
an information item indicating whether the first wireless device supports an optional TB sensing measurement role;
an information item indicating whether the first wireless device supports a non-TB sensing measurement type;
an information item indicating whether the first wireless device supports an optional non-TB sensing measurement role;
an information item indicating whether the first wireless device supports a first threshold-based sensing measurement and sensing reporting procedure;
an information item indicating whether the first wireless device, when functioning as a sensing receiver, supports transmitting a sensing measurement reporting frame to report a sensing measurement result;
an information item indicating whether the first wireless device supports reporting an aggregated sensing measurement result as a sensing initiator;
an information item indicating whether the first wireless device supports reporting an aggregated sensing measurement result as a sensing receiver;
an information item indicating whether the first wireless device supports maintaining a power for transmitting a measurement frame unchanged or undergoing a change less than a second threshold in a sensing measurement setup;
an information item indicating whether the first wireless device supports maintaining an AGC gain of receiving the measurement frame unchanged or undergoing a change less than a third threshold in a sensing measurement setup;
an information item indicating whether the first wireless device supports maintaining an antenna radiation pattern for transmitting the measurement frame unchanged or undergoing a change less than a fourth threshold in a sensing measurement setup;
an information item indicating whether the first wireless device supports maintaining an antenna radiation pattern for receiving the measurement frame unchanged or undergoing a change less than a fifth threshold in a sensing measurement setup;
an information item indicating whether the first wireless device supports compensating for a CSI report received by the first wireless device based on a power for transmitting the measurement frame by the first wireless device;
an information item indicating whether the first wireless device supports compensating for CSI calculated by the first wireless device based on a power for transmitting the measurement frame by the apparatus;
an information item indicating whether the first wireless device supports compensating for a CSI report received by the first wireless device based on an AGC gain fed back by the apparatus;
an information item indicating whether the first wireless device supports compensating for the CSI calculated by the first wireless device based on an AGC gain of receiving the measurement frame by the first wireless device; or
an information item indicating whether the first wireless device supports feeding back the AGC gain of receiving the measurement frame by the first wireless device to the apparatus.

In some embodiments of the present disclosure, the capability information of the second granularity is carried over at least one of:
a beacon frame;
a probe request frame;
a probe response frame;
an association request frame;
an association response frame;
a reassociation request frame;
a reassociation response frame; or
a measurement setup query frame.

In some embodiments of the present disclosure, the capability information of the second granularity is carried over a second type element of at least one frame, and each of the at least one information item occupies one field in the second type element.

In some embodiments of the present disclosure, the second type element is a Sensing Capabilities element.

In some embodiments of the present disclosure, the capability information of the first granularity and the capability information of the second granularity are carried over the same frame.

The capability information of the first granularity includes an information item indicating that the sensing measurement procedure is supported.

In some embodiments of the present disclosure, a first management frame includes an information item indicating that the sensing measurement procedure is not supported, wherein the first management frame includes the capability information of the first granularity but does not include the capability information of the second granularity; or a second management frame includes an information item indicating that the sensing measurement procedure is supported, wherein the second management frame includes the capability information of the first granularity, or both the capability information of the first granularity and the capability information of the second granularity.

It should be noted that the above embodiments or technical features may also be combined in pairs or more combinations according to the requirements of those skilled in the art, which are not described herein any further.

In summary, according to the apparatus for receiving capability information provided in the embodiments, the success rate of establishing a sensing measurement between devices for sensing measurement is improved by exchanging capability information related to the sensing measurement between the devices for sensing measurement.

The apparatus provided in the embodiments also makes the sensing capability information interaction between the devices for sensing measurement more comprehensive and concise by indicating, in the capability information of the first granularity, information related to whether to support the sensing measurement procedure, the sensing by proxy, the sensing constraint, and the sensing compensation.

The apparatus provided in the embodiments also makes the sensing capability information interaction between the devices for sensing measurement more comprehensive and accurate by indicating, in the capability information of the second granularity, information related to whether to support the sensing measurement procedure, the sensing by proxy, the sensing constraint, and the sensing compensation using finer granularity information items.

It should be noted that, for the apparatus according to the embodiments described above, the division of the functional modules is merely exemplary. In practice, the functions described above may be assigned to different functional modules as needed, that is, the device may be divided into different functional modules, to implement all or a part of the above functions.

Regarding the apparatus in the embodiments, the specific manner in which each module performs operations has been described in detail in the embodiments related to the method and is not described in detail herein.

FIG. 18 illustrates a schematic structural diagram of a device 1800 for sensing measurement (an AP or an STA) according to some exemplary embodiments of the present disclosure. The device 1800 for sensing measurement includes: a processor 1801, a receiver 1802, a transmitter 1803, a memory 1804, and a bus 1805.

The processor 1801 includes one or more processing cores. The processor 1801 runs various functional applications and performs information processing by running software programs and modules.

The receiver 1802 and the transmitter 1803 may be implemented as a communication assembly, which may be a communication chip.

The memory 1804 is connected to the processor 1801 via the bus 1805. The memory 1804 is configured to store at least one instruction, and the processor 1801 is configured to execute the at least one instruction to perform the processes in the above method embodiments.

In addition, the memory 1804 is practiced by any type of volatile or non-volatile storage device or a combination thereof. The volatile or non-volatile storage device includes but is not limited to: a magnetic or optical disk, an electrically erasable programmable read-only memory (EEPROM), an erasable programmable read-only memory (EPROM), a static random-access memory (SRAM), a read-only memory (ROM), a magnetic memory, a flash memory, or a programmable read-only memory (PROM).

In some exemplary embodiments, a computer-readable storage medium is further provided. The computer-readable storage medium stores at least one program. The at least one program, when loaded and run by a processor, causes the processor to perform the method for transmitting/receiving capability information according to the method embodiments described above.

In some exemplary embodiments, a chip is further provided. The chip includes one or more programmable logic circuits and/or one or more program instructions. A device for sensing measurement equipped with the chip, when running, is caused to perform the method for transmitting/receiving capability information according to the method embodiments described above.

In some exemplary embodiments, a computer program product is further provided. The computer program product, when running on a processor of a device for sensing measurement, causes the device for sensing measurement to perform the method for transmitting/receiving capability information described above.

Those skilled in the art should understand that in one or more of the above embodiments, the functions described in the embodiments of the present disclosure are practiced by hardware, software, firmware, or any combination thereof. In the case that the functions are practiced by the software, the functions are stored in a computer-readable medium or transmitted as one or more instructions or codes on the computer-readable medium. The computer-readable medium includes a computer storage medium and a communication medium. The communication medium includes any medium that facilitates the transfer of a computer program from one place to another. The storage medium is any available medium that is accessible by a general-purpose or special-purpose computer.

Described above are merely exemplary embodiments of the present disclosure, and are not intended to limit the present disclosure. Any modifications, equivalent substitutions, improvements, and the like, made within the spirit and principle of the present disclosure should fall within the protection scope of the present disclosure.

1. A method for transmitting capability information, comprising:
transmitting, by a first wireless device, capability information related to a sensing measurement to a second wireless device, wherein the capability information related to the sensing measurement comprises at least one of capability information of a first granularity or capability information of a second granularity,
wherein the first granularity is greater than the second granularity.

2. The method according to claim 1, wherein the capability information of the first granularity comprises at least one of:
an information item indicating whether to support a sensing measurement procedure;
an information item indicating whether to support a sensing-by-proxy measurement procedure;
an information item indicating whether to support a sensing constraint; or
an information item indicating whether to support a sensing compensation.

3. The method according to claim 2, wherein the capability information of the first granularity is carried over at least one of:
a beacon frame;
a probe request frame;
a probe response frame;
an association request frame;
an association response frame;
a reassociation request frame;
a reassociation response frame; or
a measurement setup query frame.

4. The method according to claim 3, wherein the capability information of the first granularity is carried over a first type element of the at least one frame, and each of the at least one information item occupies one field in the first type element.

5. The method according to claim 4, wherein the first type element is an Extended Capabilities element.

6. The method according to claim 1, wherein the capability information of the second granularity comprises at least one of:
an information item indicating whether the first wireless device supports a trigger-based sensing measurement type;
an information item indicating whether the first wireless device supports an optional trigger-based sensing measurement role;
an information item indicating whether the first wireless device supports a non-trigger-based sensing measurement type;
an information item indicating whether the first wireless device supports an optional non-trigger-based sensing measurement role;
an information item indicating whether the first wireless device supports a first threshold-based sensing measurement and sensing reporting procedure;
an information item indicating whether the first wireless device, in a case of functioning as a sensing receiver, supports transmitting a sensing measurement reporting frame to report a sensing measurement result;
an information item indicating whether the first wireless device supports reporting an aggregated sensing measurement result as a sensing initiator;
an information item indicating whether the first wireless device supports reporting an aggregated sensing measurement result as a sensing receiver;
an information item indicating whether the first wireless device supports maintaining a power for transmitting a measurement frame unchanged or undergoing a change less than a second threshold in a sensing measurement setup;
an information item indicating whether the first wireless device supports maintaining an AGC gain of receiving the measurement frame unchanged or undergoing a change less than a third threshold in a sensing measurement setup;
an information item indicating whether the first wireless device supports maintaining an antenna radiation pattern for transmitting the measurement frame unchanged or undergoing a change less than a fourth threshold in a sensing measurement setup;
an information item indicating whether the first wireless device supports maintaining an antenna radiation pattern for receiving the measurement frame unchanged or undergoing a change less than a fifth threshold in a sensing measurement setup;
an information item indicating whether the first wireless device supports compensating for a channel state information (CSI) report received by the first wireless device based on a power for transmitting the measurement frame by the first wireless device;
an information item indicating whether the first wireless device supports compensating for CSI calculated by the first wireless device based on a power for transmitting the measurement frame by the second wireless device;
an information item indicating whether the first wireless device supports compensating for CSI report received by the first wireless device based on an AGC gain fed back by the second wireless device;
an information item indicating whether the first wireless device supports compensating for CSI calculated by the first wireless device based on an AGC gain from receiving the measurement frame by the first wireless device; or
an information item indicating whether the first wireless device supports feeding back an AGC gain from receiving the measurement frame by the first wireless device to the second wireless device.

7. The method according to claim 6, wherein the capability information of the second granularity is carried over at least one of:
a beacon frame;
a probe request frame;
a probe response frame;
an association request frame;
an association response frame;
a reassociation request frame;
a reassociation response frame; or
a measurement setup query frame.

8. The method according to claim 7, wherein the capability information of the second granularity is carried over a second type element of the at least one frame, and each of the at least one information item occupies one field in the second type element.

9. The method according to claim 8, wherein the second type element is a Sensing Capabilities element.

10. A device for sensing measurement, comprising:
a processor;
a transceiver, communicably connected to the processor; and
a memory, configured to store one or more executable instructions,
wherein the processor, when loading and executing the one or more executable instructions, causes the device for sensing measurement to perform:
transmitting, by a first wireless device, capability information related to a sensing measurement to a second wireless device, wherein the capability information related to the sensing measurement comprises at least one of capability information of a first granularity or capability information of a second granularity,
wherein the first granularity is greater than the second granularity.

11. The device according to claim 10, wherein the capability information of the first granularity comprises at least one of:
an information item indicating whether to support a sensing measurement procedure;
an information item indicating whether to support a sensing-by-proxy measurement procedure;
an information item indicating whether to support a sensing constraint; or
an information item indicating whether to support a sensing compensation.

12. The device according to claim 11, wherein the capability information of the first granularity is carried over at least one of:
a beacon frame;
a probe request frame;
a probe response frame;
an association request frame;
an association response frame;
a reassociation request frame;
a reassociation response frame; or
a measurement setup query frame.

13. The device according to claim 12, wherein the capability information of the first granularity is carried over a first type element of the at least one frame, and each of the at least one information item occupies one field in the first type element.

14. A device for sensing measurement, comprising:
a processor;
a transceiver, communicably connected to the processor; and
a memory, configured to store one or more executable instructions,
wherein the processor, when loading and executing the one or more executable instructions, causes the device for sensing measurement to perform:
receiving, by a second wireless device, capability information related to a sensing measurement from a first wireless device, wherein the capability information related to the sensing measurement comprises at least one of capability information of a first granularity or capability information of a second granularity,
wherein the first granularity is greater than the second granularity.

15. The device according to claim 14, wherein the capability information of the first granularity comprises at least one of:
an information item indicating whether to support a sensing measurement procedure;
an information item indicating whether to support a sensing-by-proxy measurement procedure;
an information item indicating whether to support a sensing constraint; or
an information item indicating whether to support a sensing compensation.

16. The device according to claim 15, wherein the capability information of the first granularity is carried over at least one of:
a beacon frame;
a probe request frame;
a probe response frame;
an association request frame;
an association response frame;
a reassociation request frame;
a reassociation response frame; or
a measurement setup query frame.

17. The device according to claim 15, wherein the capability information of the first granularity is carried over a first type element of the at least one frame, and each of the at least one information item occupies one field in the first type element.

18. The device according to claim 17, wherein the first type element is an Extended Capabilities element.

19. The device according to claim 14, wherein the capability information of the second granularity comprises at least one of:
an information item indicating whether the first wireless device supports a trigger-based sensing measurement type;
an information item indicating whether the first wireless device supports an optional trigger-based sensing measurement role;
an information item indicating whether the first wireless device supports a non-trigger-based sensing measurement type;
an information item indicating whether the first wireless device supports an optional non-trigger-based sensing measurement role;
an information item indicating whether the first wireless device supports a first threshold-based sensing measurement and sensing reporting procedure;
an information item indicating whether the first wireless device, in a case of functioning as a sensing receiver, supports transmitting a sensing measurement reporting frame to report a sensing measurement result;
an information item indicating whether the first wireless device supports reporting an aggregated sensing measurement result as a sensing initiator;
an information item indicating whether the first wireless device supports reporting an aggregated sensing measurement result as a sensing receiver;
an information item indicating whether the first wireless device supports maintaining a power for transmitting a measurement frame unchanged or undergoing a change less than a second threshold in a sensing measurement setup;
an information item indicating whether the first wireless device supports maintaining an AGC gain of receiving the measurement frame unchanged or undergoing a change less than a third threshold in a sensing measurement setup;
an information item indicating whether the first wireless device supports maintaining an antenna radiation pattern for transmitting the measurement frame unchanged or undergoing a change less than a fourth threshold in a sensing measurement setup;
an information item indicating whether the first wireless device supports maintaining an antenna radiation pattern for receiving the measurement frame unchanged or undergoing a change less than a fifth threshold in a sensing measurement setup;
an information item indicating whether the first wireless device supports compensating for a channel state information (CSI) report received by the first wireless device based on a power for transmitting the measurement frame by the first wireless device;
an information item indicating whether the first wireless device supports compensating for CSI calculated by the first wireless device based on a power for transmitting the measurement frame by the second wireless device;
an information item indicating whether the first wireless device supports compensating for CSI report received by the first wireless device based on an AGC gain fed back by the second wireless device;
an information item indicating whether the first wireless device supports compensating for CSI calculated by the first wireless device based on an AGC gain of receiving the measurement frame by the first wireless device; or
an information item indicating whether the first wireless device supports feeding back an AGC gain of receiving the measurement frame by the first wireless device to the second wireless device.

20. The device according to claim 19, wherein the capability information of the second granularity is carried over at least one of:
a beacon frame;
a probe request frame;
a probe response frame;
an association request frame;
an association response frame;
a reassociation request frame;
a reassociation response frame; or
a measurement setup query frame.
